(19) United States
(12) Patent Application Publication
(10) Pub. No.: US 2021/0149170 A1
(43) Pub. Date: May 20, 2021

(54) METHOD AND APPARATUS FOR Z-STACK ACQUISITION FOR MICROSCOPIC SLIDE SCANNER

(71) Applicant: SCOPIO LABS LTD., Tel Aviv (IL)

(72) Inventors: Ben LESHEM, Tel Aviv (IL); Eran SMALL, Yehud (IL); Erez NA'AMAN, Tel Aviv (IL)

(73) Assignee: SCOPIO LABS LTD., Tel Aviv (IL)

(21) Appl. No.: 17/098,099

(22) Filed: Nov. 13, 2020

Related U.S. Application Data
(60) Provisional application No. 62/935,796, filed on Nov. 15, 2019.

(51) Int. Cl. G02B 21/00; G02B 21/36

(52) U.S. Cl. CPC G02B 21/006; G02B 21/008; G02B 21/367; G02B 21/0032

(57) ABSTRACT

A scanning microscope for z-stack acquisition may include, a stage to hold a sample, an illumination source to illuminate the sample, and an image capture device configured to capture multiple images of the sample within a field of view of the image capture device. The microscope may also include a lateral actuator for changing a relative lateral position between the image capture device and an imaged portion of the sample within the field of view of the image capture device for each of the images, and a focus actuator configured to adjust a focal distance between the sample and the image capture device between each of the images. The microscope may further include a processor connected to the lateral actuator and the focus actuator to move the sample laterally relative to the field of view and capture an area of the sample for each of multiple movement paths.

### RELATED APPLICATIONS

This application claims the benefit under 35 U.S.C. § 119(e) of U.S. Provisional Patent Application No. 62/935,796, filed Nov. 15, 2019, and titled “METHOD FOR Z-STACK ACQUISITION FOR MICROSCOPIC SLIDE SCANNER,” which is incorporated, in its entirety, by this reference.

### BACKGROUND

Whole-slide digital microscopy involves scanning a large area of a sample mounted on a slide. Because the large area may not be captured completely within a field of view (“FOV”) of a digital microscope, the digital microscope may instead capture a series of different FOV images and stitch them together to form a continuous large digital image representing the sample in the slide. Although, the digital microscope can stitch together the different images to form one large image, work in relation to the present disclosure suggests that the prior approaches can take longer than would be ideal and result in less than ideal images in at least some instances. Also, the prior approaches may have less than ideal overlap among different planes which can lead to stitched images that are less than ideal in at least some instances.

Typically, the series of images is acquired by mechanically moving the slide and capturing a single image in each location. The sample may be stopped at each location, focused, captured, and then moved again in a time-consuming process. To generate a sufficiently large dataset can be more time-consuming than would be ideal, because the sample is stopped at each location and then moved again to the next location, which for a large sample can result in an acquisition time of several minutes, in at least some instances.

To more efficiently capture the series of images, the digital microscope may rely on a scanning scheme in which the focus at each location may not be verified before capturing the image. Although such approaches may use a shortened exposure time to capture the images, delays may result from sufficiently slowing down movement to reduce motion blur. Although real-time autofocusing may be available, such solutions may be inaccurate, prohibitively slow, and/or may require expensive dedicated hardware in at least some instances. Thus, although conventional digital microscopes may rely on constructing a focus map of the slide prior to the scanning process, the scanning process can still take longer than would be ideal.

The focus map may estimate a desired focal distance between the image capture device and the sample at the locations for capturing images. However, because the focus map may only provide an estimation of the continuous focus change throughout the slide from a finite number of points, its accuracy may inherently be limited in at least some instances. Moreover, the focus map may not be able to account for local changes in focus, such as due to changes in a structure of the sample. In addition, samples that are thick in comparison to the depth of field of the optical system of the digital microscope may not be imaged properly, resulting in poor image quality.

In light of the above, there is a need for improved methods and apparatus for generating images that ameliorate at least some of the above limitations.

### SUMMARY

The systems and methods described herein provide improved microscope scanning with decreased time and improved image quality. In some embodiments, the sample moves continuously in a lateral direction while a plurality of images is acquired at different focal planes within the sample, which can decrease the amount of time to scan a sample along a plurality of focal planes extending across several fields of view. In some embodiments, a series of images is acquired at different focal planes and lateral offsets while the sample moves continuously in a lateral direction allows for the correction of focus errors. In some embodiments, the combined image comprises a plurality of in focus images selected from the images acquired at the different focal planes. The systems and methods described herein may use slide scanner that may include a light source, a slide to be scanned, an imaging system that may include an objective lens and a tube lens, a motor for shifting optical focus, a camera for acquiring images, and a stage to shift the slide laterally.

A speed of lateral scanning may be set such that a size of the lateral shift between frames may be a fraction of the length of a FOV. In some embodiments, the sample moves laterally in relation to the imaging device while a frame is captured to decrease the overall scan time. In some embodiments, the focus of the imaging system may be shifted repeatedly along the optical axis during continuous lateral movement of the sample, such as in a synchronized manner, in order to allow for the capture of a plurality of images of the sample at a plurality of planes in which the field of view of the sample is offset for each of the plurality of images. In some embodiments, the captured images may advantageously image the entire FOV at different focal planes and lateral positions of the sample, which may be helpful for enhancing image quality. In some embodiments, the offset FOV of the sample for each of the plurality of images at each of the plurality of focal planes can provide increased overlap among different imaged planes of the sample, which can improve the image quality of combined images such as stitched images and can generate z-stack images of a sample area substantially larger than the FOV with fewer image artifacts and decreased scan times.

### INCORPORATION BY REFERENCE

All patents, applications, and publications referred to and identified herein are hereby incorporated by reference in their entirety and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 shows a diagram of an exemplary microscope, in accordance with some embodiments;

FIG. 2 shows a diagram of a slide scanner, in accordance with some embodiments;

FIG. 3 shows a flow chart of a method of Z-stack acquisition, in accordance with some embodiments;

FIG. 4 shows a graph of focal distance over time, in accordance with some embodiments; and

FIG. 5 shows a graph of focal distance over time in conjunction with a focus map, in accordance with some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

The present disclosure is generally directed to systems and methods for z-stack acquisition for a microscopic scanner that may allow for correction of focus errors. As will be explained in greater detail below, embodiments of the instant disclosure may be configured to perform image captures at various focal planes while laterally shifting a sample. The resulting images may advantageously capture multiple focal planes of a lateral area that may be used to correct any out-of-focus issues. In addition, the lateral areas may be stitched together to a large, in-focus area of the sample. The systems and methods described herein may improve the field of digital slide scanners by correcting the deterioration of image quality due to either inexact focus or thickness of the sample that requires acquiring multiple focal planes. Acquisition time may be significantly reduced by avoiding unnecessary image captures using focal planes which may not contribute additional data but may be used solely for focusing. The user experience may be improved, for example, because the system may provide high-quality images without requiring the user to determine focus maps in advance. In addition, the systems and methods described herein may not require expensive hardware solutions for focus errors.

Tomography refers generally to methods where a three-dimensional (3D) sample is sliced computationally into several 2D slices. Confocal microscopy refers to methods for blocking out-of-focus light in the image formation which improves resolution and contrast but tends to lead to focusing on a very thin focal plane and small field of view. Both tomography and confocal microscopy as well as other methods used in 3D imaging may be used in conjunction with aspects of the present disclosure to produce improved results. Another method may be staggered line scan sensors, where the sensor has several line scanners at different heights and or angles, and the sensor may take images at several focus planes at the same time.

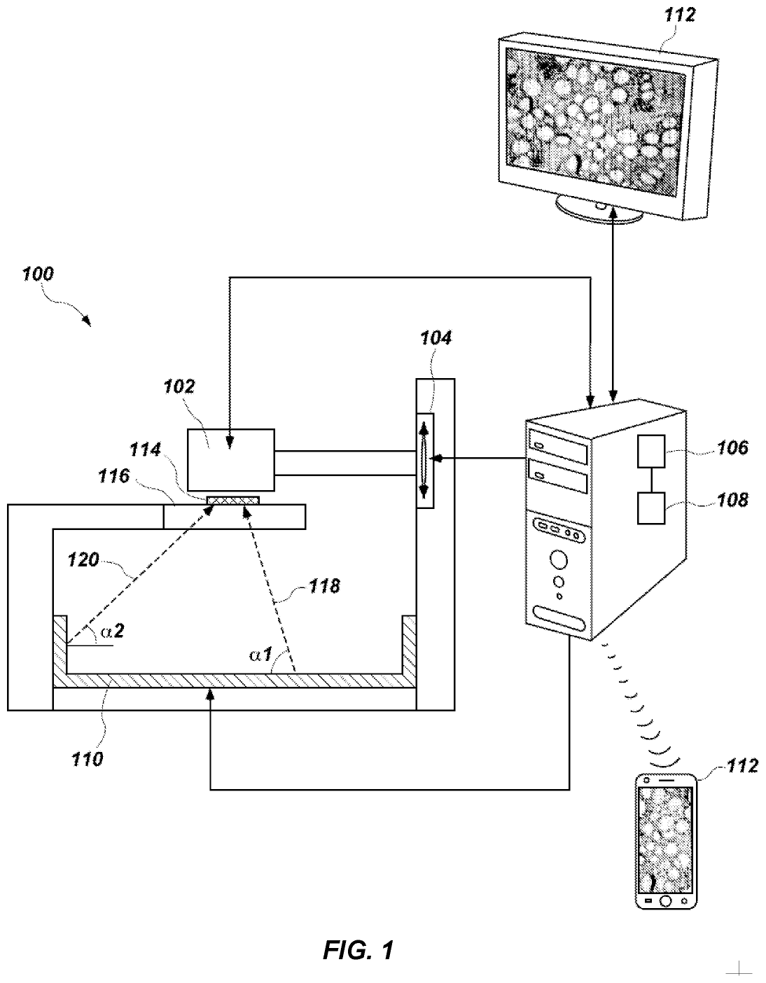

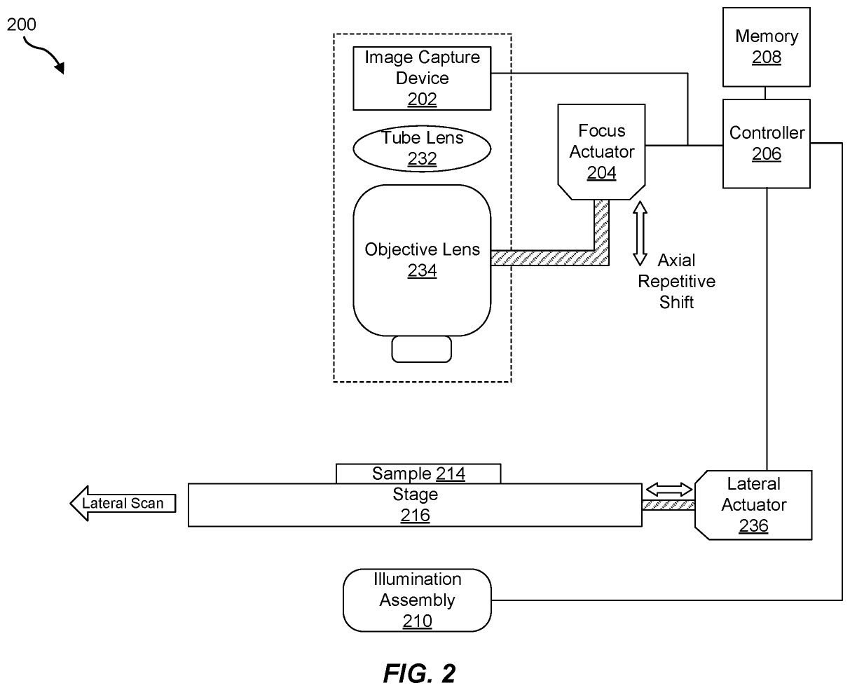

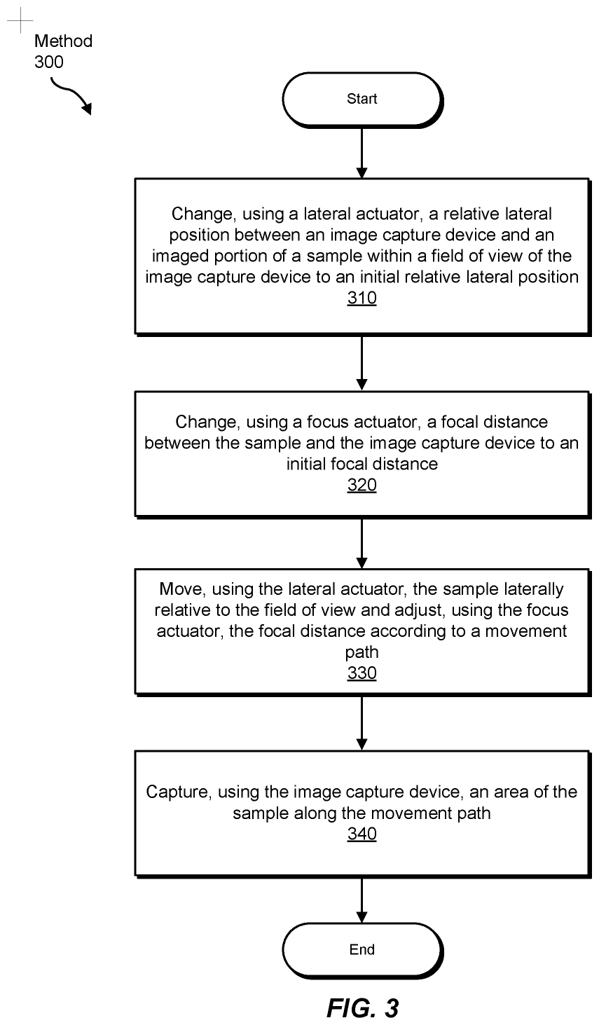

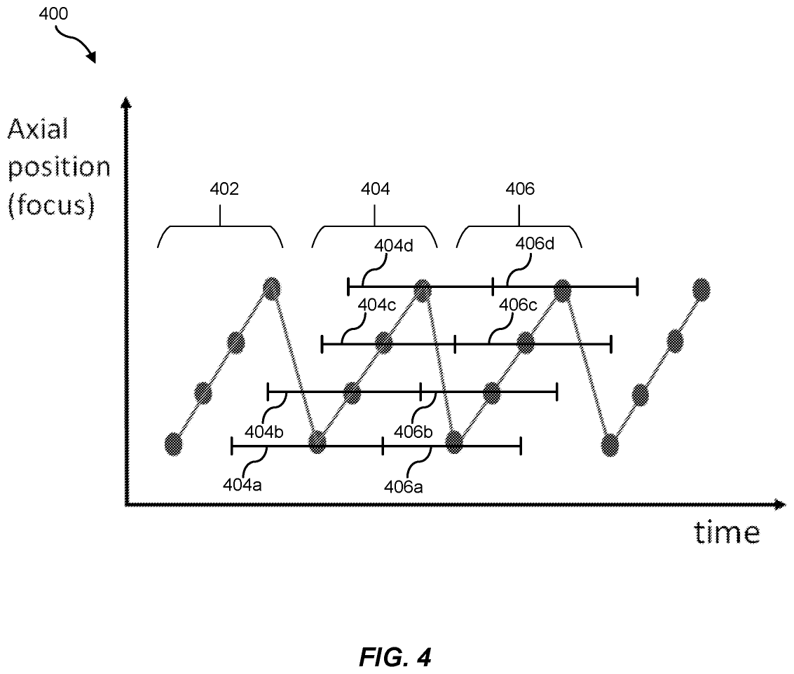

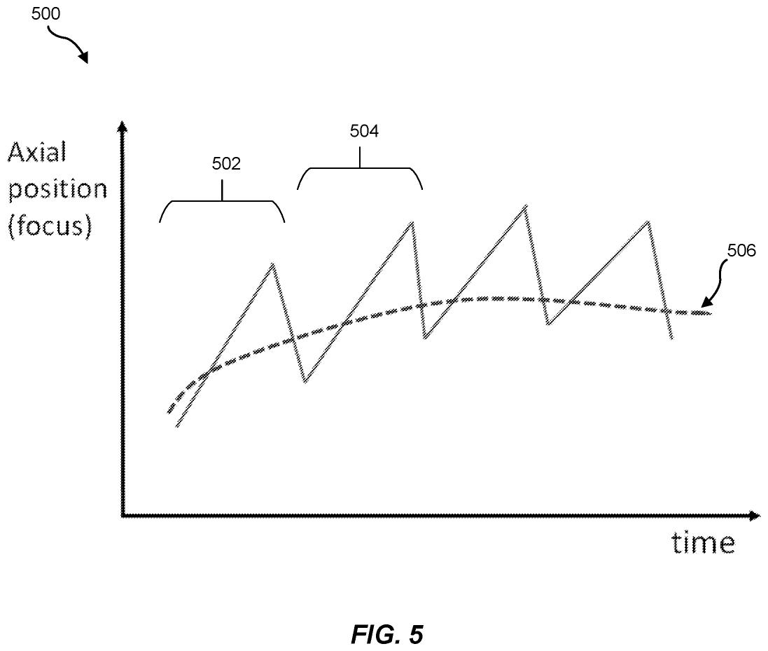

The following will provide, with reference to FIGS. 1-5, detailed descriptions of z-stack acquisition for a microscope slide scanner. FIGS. 1 and 2 illustrate a microscope and various microscope configurations. FIG. 3 illustrates an exemplary process for z-stack acquisition. FIGS. 4-5 show exemplary graphs for focal distance over time.

FIG. 1 is a diagrammatic representation of a microscope 100 consistent with the exemplary disclosed embodiments. The term “microscope” as used herein generally refers to any device or instrument for magnifying an object which is smaller than easily observable by the naked eye, i.e., creating an image of an object for a user where the image is larger than the object. One type of microscope may be an “optical microscope” that uses light in combination with an optical system for magnifying an object. An optical microscope may be a simple microscope having one or more magnifying lens. Another type of microscope may be a “computational microscope” that comprises an image sensor and image-processing algorithms to enhance or magnify the object's size or other properties. The computational microscope may be a dedicated device or created by incorporating software and/or hardware with an existing optical microscope to produce high-resolution digital images. As shown in FIG. 1, microscope 100 comprises an image capture device 102, a focus actuator 104, a controller 106 connected to memory 108, an illumination assembly 110, and a user interface 112. An example usage of microscope 100 may be capturing images of a sample 114 mounted on a stage 116 located within the field-of-view (FOV) of image capture device 102, processing the captured images, and presenting on user interface 112 a magnified image of sample 114.

Image capture device 102 may be used to capture images of sample 114. In this specification, the term “image capture device” as used herein generally refers to a device that records the optical signals entering a lens as an image or a sequence of images. The optical signals may be in the near-infrared, infrared, visible, and ultraviolet spectrums. Examples of an image capture device comprise a CCD camera, a CMOS camera, a color camera, a photo sensor array, a video camera, a mobile phone equipped with a camera, a webcam, a preview camera, a microscope objective and detector, etc. Some embodiments may comprise only a single image capture device 102, while other embodiments may comprise two, three, or even four or more image capture devices 102. In some embodiments, image capture device 102 may be configured to capture images in a defined field-of-view (FOV). Also, when microscope 100 comprises several image capture devices 102, image capture devices 102 may have overlap areas in their respective FOVs. Image capture device 102 may have one or more image sensors (not shown in FIG. 1) for capturing image data of sample 114. In other embodiments, image capture device 102 may be configured to capture images at an image resolution higher than VGA, higher than 1 Megapixel, higher than 2 Megapixels, higher than 5 Megapixels, 10 Megapixels, higher than 12 Megapixels, higher than 15 Megapixels, or higher than 20 Megapixels. In addition, image capture device 102 may also be configured to have a pixel size smaller than 15 micrometers, smaller than 10 micrometers, smaller than 5 micrometers, smaller than 3 micrometers, or smaller than 1.6 micrometer.

In some embodiments, microscope 100 comprises focus actuator 104. The term “focus actuator” as used herein generally refers to any device capable of converting input signals into physical motion for adjusting the relative distance between sample 114 and image capture device 102. Various focus actuators may be used, including, for example, linear motors, electrostrictive actuators, electrostatic motors, capacitive motors, voice coil actuators, magnetostrictive actuators, etc. In some embodiments, focus actuator 104 may comprise an analog position feedback sensor and/or a digital position feedback element. Focus actuator 104 is configured to receive instructions from controller 106 in order to make light beams converge to form a clear and sharply defined image of sample 114. In the example illustrated in FIG. 1, focus actuator 104 may be configured to adjust the distance by moving image capture device 102.

However, in other embodiments, focus actuator 104 may be configured to adjust the distance by moving stage 116, or by moving both image capture device 102 and stage 116. Microscope 100 may also comprise controller 106 for controlling the operation of microscope 100 according to the disclosed embodiments. Controller 106 may comprise various types of devices for performing logic operations on one or more inputs of image data and other data according to stored or accessible software instructions providing desired functionality. For example, controller 106 may comprise a central processing unit (CPU), support circuits, digital signal processors, integrated circuits, cache memory, or any other types of devices for image processing and analysis such as graphic processing units (GPUs). The CPU may comprise any number of microcontrollers or microprocessors configured to process the imagery from the image sensors. For example, the CPU may comprise any type of single- or multi-core processor, mobile device microcontroller, etc. Various processors may be used, including, for example, processors available from manufacturers such as Intel®, AMD®, etc. and may comprise various architectures (e.g., x86 processor, ARM®, etc.). The support circuits may be any number of circuits generally well known in the art, including cache, power supply, clock and input-output circuits. Controller 106 may be at a remote location, such as a computing device communicatively coupled to microscope 100.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106.

Specifically, memory 108 may refer to multiple structures or computer-readable storage mediums located at controller 106 or at a remote location, such as a cloud server. Memory 108 may comprise any number of random access memories, read only memories, flash memories, disk drives, optical storage, tape storage, removable storage and other types of storage.

Microscope 100 may comprise illumination assembly 110. The term “illumination assembly” as used herein generally refers to any device or system capable of projecting light to illuminate sample 114.

Illumination assembly 110 may comprise any number of light sources, such as light emitting diodes (LEDs), LED array, lasers, and lamps configured to emit light, such as a halogen lamp, an incandescent lamp, or a sodium lamp. For example, illumination assembly 110 may comprise a Kohler illumination source. Illumination assembly 110 may be configured to emit polychromatic light. For instance, the polychromatic light may comprise white light.

In one embodiment, illumination assembly 110 may comprise only a single light source. Alternatively, illumination assembly 110 may comprise four, sixteen, or even more than a hundred light sources organized in an array or a matrix. In some embodiments, illumination assembly 110 may use one or more light sources located at a surface parallel to illuminate sample 114. In other embodiments, illumination assembly 110 may use one or more light sources located at a surface perpendicular or at an angle to sample 114.

In addition, illumination assembly 110 may be configured to illuminate sample 114 in a series of different illumination conditions. In one example, illumination assembly 110 may comprise a plurality of light sources arranged in different illumination angles, such as a two-dimensional arrangement of light sources. In this case, the different illumination conditions may comprise different illumination angles. For example, FIG. 1 depicts a beam 118 projected from a first illumination angle al, and a beam 120 projected from a second illumination angle a2. In some embodiments, first illumination angle al and second illumination angle a2 may have the same value but opposite sign. In other embodiments, first illumination angle al may be separated from second illumination angle a2. However, both angles originate from points within the acceptance angle of the optics. In another example, illumination assembly 110 may comprise a plurality of light sources configured to emit light in different wavelengths. In this case, the different illumination conditions may comprise different wavelengths. For instance, each light source may be configured to emit light with a full width half maximum bandwidth of no more than 50 nm so as to emit substantially monochromatic light. In yet another example, illumination assembly 110 may configured to use a number of light sources at predetermined times. In this case, the different illumination conditions may comprise different illumination patterns. For example, the light sources may be arranged to sequentially illuminate the sample at different angles to provide one or more of digital refocusing, aberration correction, or resolution enhancement. Accordingly and consistent with the present disclosure, the different illumination conditions may be selected from a group including: different durations, different intensities, different positions, different illumination angles, different illumination patterns, different wavelengths, or any combination thereof. In some embodiments, the light sources are configured to illuminate the sample with each of the plurality of illumination conditions for an amount of time within a range from about 0.5 milliseconds to about 20 milliseconds, for example within a range from about 1 millisecond to about 10 milliseconds. In some embodiments, the relative lateral movement occurs for the duration of each of the plurality of illumination conditions.

Consistent with disclosed embodiments, microscope 100 may comprise, be connected with, or in communication with (e.g., over a network or wirelessly, e.g., via Bluetooth) user interface 112. The term “user interface” as used herein generally refers to any device suitable for presenting a magnified image of sample 114 or any device suitable for receiving inputs from one or more users of microscope 100. FIG. 1 illustrates two examples of user interface 112. The first example is a smartphone or a tablet wirelessly communicating with controller 106 over a Bluetooth, cellular connection or a Wi-Fi connection, directly or through a remote server. The second example is a PC display physically connected to controller 106. In some embodiments, user interface 112 may comprise user output devices, including, for example, a display, tactile device, speaker, etc. In other embodiments, user interface 112 may comprise user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

Microscope 100 may also comprise or be connected to stage 116. Stage 116 comprises any horizontal rigid surface where sample 114 may be mounted for examination. Stage 116 may comprise a mechanical connector for retaining a slide containing sample 114 in a fixed position. The mechanical connector may use one or more of the following: a mount, an attaching member, a holding arm, a clamp, a clip, an adjustable frame, a locking mechanism, a spring or any combination thereof. In some embodiments, stage 116 may comprise a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

FIG. 2 illustrates a basic schematic of an exemplary slide scanner according to some embodiments. FIG. 2 illustrates a microscope 200 (which may correspond to microscope 100), that may include a image capture device 202 (which may correspond to image capture device 102), a focus actuator 204 (which may correspond to focus actuator 104), a controller 206 (which may correspond to controller 106) connected to a memory 208 (which may correspond to memory 108), an illumination assembly 210 (which may correspond to illumination assembly 110), a tube lens 232, an objective lens 234, a sample 214 mounted on a stage 216 (which may correspond to stage 116), and a lateral actuator 236. Tube lens 232 and objective lens 234 may function in unison to focus light of a focal plane (which may be determined based on a position of objective lens 234 as adjusted by focus actuator 204) of sample 214 in an FOV of image capture device 202. Tube lens 232 may comprise a multi-element lens apparatus in a tube shape, which focuses light in conjunction with objective lens 234. Lateral actuator 236 may comprise a motor or other actuator described herein that may be capable of physically moving stage 226 laterally in order to adjust a relative lateral position between sample 214 and image capture device 202. In some examples, focus actuator 204 and/or lateral actuator 236 may comprise a coarse actuator for long range motion and a fine actuator for short range motion. The coarse actuator may remain fixed while the fine focus actuator of focus actuator 204 adjusts the focal distance and lateral actuator 236 moves the lateral position of sample 214 for the movement paths. The coarse actuator may comprise a stepper motor and/or a servo motor, for example. The fine actuator may comprise a piezo electric actuator. The fine actuator may be configured to move sample 214 by a maximum amount within a range from 5 microns to 500 microns. The coarse actuator may be configured to move sample 214 by a maximum amount within a range from 1 mm to 100 mm.

Stage 216 may be configured to hold sample 214. Illumination assembly 210 may comprise an illumination source configured to illuminate sample 214. Image capture device 202 may be configured to capture multiple images or frames of sample 214 within an FOV of image capture device 202. Lateral actuator 236 may be configured to change a relative lateral position between image capture device 202 and an imaged portion of sample 214 within the FOV of image capture device 202 for each of the multiple images. Focus actuator 204 may be configured to adjust a focal distance (e.g., focal plane) between sample 214 and image capture device 202 between each of the multiple captured images. Controller 206, may comprise a processor operatively coupled to lateral actuator 236, focus actuator 204, image capture device 202, and/or illumination assembly 210 in order to move sample 214 laterally relative to the FOV and capture an area of sample 214 multiple time, for example at least three times for at least three lateral positions and at least three focal planes for each of multiple movement paths. In some examples, lateral actuator 236 and focus actuator 204 may move simultaneously to define the plurality of movement paths such that each of the movement paths includes at least three focal planes and at least three lateral positions. In some examples, controller 206 may be configured to apply each of multiple light colors (using illumination assembly 210) for a first iteration of the movement paths and to apply each of the multiple light colors for a second iteration of the movement paths.

Although the examples herein describe adjusting the relative lateral position by physically moving stage 216, in other embodiments the relative lateral position may be adjusted in other ways, including moving/shifting one or more of image capture device 202, tube lens 232, objective lens 234, sample 214, and/or stage 216. Likewise, although the examples herein describe adjusting the focal distance by physically moving objective lens 234, in other embodiments the focal distance may be adjusted in other ways, including moving/shifting one or more of image capture device 202, tube lens 232, objective lens 234, sample 214, and/or stage 216.

FIG. 3 illustrates a flow chart of an exemplary method 300 for z-stack acquisition for a microscope slide scanner. In one example, each of the steps shown in FIG. 3 may represent an algorithm whose structure includes and/or is represented by multiple sub-steps, examples of which will be provided in greater detail below.

As illustrated in FIG. 3, at step 310 one or more of the systems described herein may change, using a lateral actuator, a relative lateral position between an image capture device and an imaged portion of a sample within a field of view of the image capture device to an initial relative lateral position. For example, controller 206 may change, using lateral actuator 236 to move stage 216, a relative lateral position between image capture device 202 (and/or tube lens 232 and objective lens 234) and an imaged portion of sample 214 within an FOV of image capture device 202 to an initial relative lateral position. As will be described further below, the initial relative lateral position may correspond to an initial relative lateral position of a current iteration of scanning according to a current movement path. Although reference is made to moving the sample, in some embodiments the sample remains fixed while one or more components of the image capture device is moved to provide the change in relative lateral position.

At step 320 one or more of the systems described herein may change, using a focus actuator, a focal distance between the sample and the image capture device to an initial focal distance. For example, controller 206, using focus actuator 204 to move objective lens 234, may change a focal distance between sample 214 and image capture device 202 to an initial focal distance. As will be described further below, the initial focal distance may correspond to an initial focal distance of a current iteration of scanning according to the current movement path. Although the focal distance can be changed by moving one or more components of the image capture device, in some alternative embodiments the focal distance can be changed by moving the stage while the image capture device remains fixed.

At step 330 one or more of the systems described herein may move, using the lateral actuator, the sample laterally relative to the field of view and adjust, using the focus actuator, the focal distance according to a movement path. For example, controller 206 may move, using lateral actuator 236, sample 214 laterally relative to the FOV. Controller 206 may also concurrently adjust, using focus actuator 204, the focal distance according to the movement path, as will be described further below.

At step 340 one or more of the systems described herein may capture, using the image capture device, an area of the sample along the movement path. For example, controller 206 may capture, using image capture device 202, an area of sample 214 along the movement path, as will be described further below. Method 300 may correspond to a single movement path or iterations thereof, and may repeat, shifting the focal distance and lateral position as needed.

The method 300 of z-stack acquisition can be performed in many ways as will be appreciated by one of ordinary skill in the art, and the steps shown can be performed in any suitable order, and some of the steps can be omitted or repeated. Some of the steps may comprises sub-steps of other steps and some of the steps can be combined. In some embodiments, one or more of the movements comprises a stepwise movement. For example, the lateral actuator can be used to move the sample laterally in a step wise manner for each of the acquired images. Alternatively, the lateral actuator can move the sample continuously without stopping during the movement along one or more of the movement paths. Similarly, the focus actuator can be used to adjust the focal distance in a stepwise manner or with continuous movement.

FIG. 4 illustrates a graph 400 corresponding to a plurality of movement paths, according to some embodiments. Graph 400 illustrates a repetitive axial movement as a function of time for the example case of acquiring 4 focal planes per FOV. The points may indicate moments when an image is captured. FIG. 4 illustrates four movement paths, including a first movement path 402, a second movement path 404, and a third movement path 406. The axial position (focus) corresponds to the axial position of the focal plane in the sample, and time illustrates the relative lateral shift of the sample.

Any suitable number of axial and lateral positions can be used. In some embodiments, at least three focal planes are located at a plurality of axial positions along an optical axis of the image capture device. In some embodiments, the plurality of axial positions comprises at least three axial positions. In some embodiments, the plurality of axial positions comprises a first axial position and a second axial position, in which a first focal plane is located at the first axial position and a second focal plane and a third focal plane are located at the second axial position, for example.

In some embodiments, each of the plurality of movement paths 402, 404, 406 comprises continuous lateral movement of the sample with a speed, such that time corresponds to a lateral position of the FOV on the sample. Alternatively, the movement may comprise stepwise movement. In some embodiments, the FOV of the sample as imaged onto the sensor is offset for each of the plurality of images at each of the plurality of focal planes. Along a movement path such as second movement path 404, a first image is acquired with a first field of view 404a of the sample at a first focal plane, a second image acquired with a second field of view 404b of the sample at a second focal plane, a third image acquired with a third field of view 404c of the sample at a third focal plane, and a fourth image acquired with a fourth field of view 404c of the sample at a fourth focal plane. Along third movement path 406, a first image is acquired with a first field of view 406a of the sample at a first focal plane, a second image acquired with a second field of view 406b of the sample at a second focal plane, a third image acquired with a third field of view 406c of the sample at a third focal plane, and a fourth image acquired with a fourth field of view 406c of the sample at a fourth focal plane. Images can be acquired similarly along the first movement path 402, and along any suitable number of movement paths. The overlap among the different imaged planes of the sample can improve the image quality of combined images such as stitched images and can generate z-stack images of a sample area substantially larger than the FOV with fewer image artifacts and decreased scan times. In some embodiments, the lateral movement occurs continuously for each of the plurality of movement paths 402, 404, 406, so as to decrease the total amount of time to scan the sample.

In some embodiments, the processor is configured with instructions to continuously move the sample laterally relative to the field of view for each of the plurality of movement paths. In some embodiments, the processor is configured with instructions to continuously move the sample laterally with a velocity relative to the field of view for each of the plurality of movement paths. The time and lateral velocity may correspond to a lateral distance of a movement path. The lateral distance of a movement path may correspond to a distance across the field of view on the sample, for example.

In some examples, the movement paths may include periodic movement of focus actuator 204 while lateral actuator 236 continues advancement of sample 214 in relation to the FOV. For instance in FIG. 2, as lateral actuator 236 moves stage 216 in a lateral scan direction (e.g., left), focus actuator 204 may periodically move up and down. As seen in FIG. 4, focus actuator 204 may move to four different locations (indicated by the points) during first movement path 402 and may reset and repeat the four locations during second movement path 404. However, the lateral position may have shifted between first movement path 402 and second movement path 404. In some examples, each movement path may correspond to a particular lateral position.

In addition, focus actuator 204 may be adjusted from a third position of a first movement path to a first position of a second movement path and focus actuator 204 may move from first, second, and third position of the second movement path while lateral actuator 236 continues advancement of sample 214 in relation to the FOV to corresponding first, second, and third lateral positions of sample 214 along the second movement path. In other words, after a final position of first movement path 402, focus actuator 204 may move to a first position of second movement path 404 while lateral actuator 236 continues lateral movement of sample 214.

In some examples, for each of multiple movement paths, lateral actuator 236 may move from a first lateral position of sample 214, to a second lateral position of sample 214, and to a third lateral position of sample 214. The second lateral position may be between the first lateral position and the third lateral position. Focus actuator 204 may move from a first focal plane position corresponding to the first lateral position, to a second focal plane position corresponding to the second lateral position, and to a third focal plane position corresponding to the third lateral position. The second focal plane position may be between the first focal plane position and third focal plane position. If the focal plane positions substantially repeat for the movement paths, the movement paths may resemble the movement paths depicted in FIG. 4. However, if the focal plane positions differ, the movement paths may resemble the movement paths depicted in FIG. 5.

FIG. 5 illustrates a graph 500 corresponding to another example movement path, according to some embodiments. Graph 500 illustrates a repetitive axial movement as a function of time when overlayed over an axial movement determined by a focus map. The dashed line may denote the axial movement determined by the focus map. The solid line may denote the repetitive axial movement generated by the methods described herein. FIG. 5 illustrates four movement paths, including a first movement path 502 and a second movement path 504. FIG. 5 also shows a focus map 506, illustrating desired focal planes over time (e.g., lateral positions). In some embodiments, each of the plurality of movement paths 502, 504 comprises continuous lateral movement of the sample with a speed, such that time corresponds to a lateral position of the FOV on the sample.

Similarly to FIG. 4, FIG. 5 depicts four movement paths, with each movement path corresponding to a different lateral position. However, unlike FIG. 4, in which the focal plane positions may substantially repeat, in FIG. 5, the focal plane positions may vary between the movement paths. Alternatively, FIG. 4 may illustrate a scenario in which the focus map is substantially flat.

In some examples, the movement paths may initially include similar focal plane positions (as in FIG. 4), but controller 206 may be configured to adjust at least one of the multiple movement paths. In some examples, controller 206 may adjust at least one of the movement paths based on a slide tilt compensation. For example, based on prior data and/or calibration data, controller 206 may be configured to compensate for a tilt in sample 214 and/or stage 216 that may tilt or otherwise shift desired focal planes. Controller 206 may accordingly adjust the movement paths. In some examples, controller 206 may adjust at least one of the movement paths based on a focus sample 214 of a prior measurement path, for instance based on a prior scan or by dynamically updating a next movement path after completing a current movement path. In some examples, controller 206 may adjust at least one of the movement paths based on a predetermined focus map.

Focus map 506 may comprise a predetermined focus map, for example. Focus map 506 may be based on a prior scan, user input, analysis from prior movement paths, etc. Focus map 506 illustrates how the desired focal planes (e.g., focal planes in sample 214 containing relevant data) may shift, for instance due to changes in the slide and/or stage 216, structural changes in sample 214, etc. Controller 206 may adjust the movement paths to resemble focus map 506, for instance by keeping the focal distances of each movement path within a particular range of focus map 506. As seen in FIG. 5, first movement path 502 may include a first range of focal planes around focus map 506 and second movement path 504 may include a second range of focal planes around focus map 506 as shifted over time. In some examples, at least one of the image capture points within a movement path may coincide with focus map 506, although not necessary.

After image capture device 202 captures the images according to the movement paths, controller 206 may be configured to further process the captured images. Controller 206 may be configured to form a focal stack from the captured images. In some examples, controller 206 may form the focal stack by identifying images of the captured images corresponding to a same lateral field of view of sample 214 at different focal planes, laterally aligning the identified images, and combining the laterally aligned images into the focal stack. For example, the captured images within a movement path may correspond to the same lateral field of view. Controller 206 may be further configured to interpolate, in a z-direction, between the acquired layers of the focal stack. Controller 206 may be configured to digitally refocus the focal stack.

In some examples, controller 206 may be configured to process the images to generate a two-dimensional (“2D”) image from the images. For example, sample 214 may include an object at different focal planes in a focal stack of images and the 2D image may comprise an in-focus image of the object from different focal planes. Controller 206 may be configured to generate the 2D image by generating the focal stack from the images, identifying a portions of the images corresponding to a same lateral field of view of the sample at the different focal planes, and combining the portions to generate the 2D image.

In some examples, controller 206 may be configured to generate the 2D image by identifying images corresponding to a same first lateral field of view of the sample at different focal planes, selecting, from the identified images corresponding to the first lateral field of view, a first in-focus image, identifying images of the plurality of images corresponding to a same second lateral field of view of the sample at different focal planes, selecting, from the identified images corresponding to the second lateral field of view, a second in-focus image, and combining the first in-focus image with the second in-focus image to create the 2D image.

In some examples, controller 206 may be configured to perform, using the images, motion blurring correction, phase retrieval, optical aberration correction, resolution enhancement, and/or noise reduction.

In some examples, controller 206 may be configured to create a three-dimensional (“3D”) reconstruction of the sample using the images.

In some examples, controller 206 may be configured to determine, based on the images, a center of mass of the sample. In some examples, determining the center of mass may include estimating a correct focus using 2D data derived from the images. In other examples, determining the center of mass may include estimating a center, in a z-direction, of 3D data derived from the images.

The systems and methods described herein may provide for efficient z-stack acquisition. For z-stack acquisition, vscan may define a lateral scanning velocity, tf may define a time between consecutive frames, and Lsensor may define a size of the sensor divided by the magnification (e.g., corresponding to the sensor size in the sample plane). Conventional slide scanners may adjust vscan such that the movement between frames (e.g., t_{f}*v_{scan}) is not larger than Lsensor. This may be necessary to capture the entire scanned area without missing any areas.

The systems and methods described herein may adjust v_{scan} such that t_{f}*v_{scan} may not be larger than Lₛₑₙₛₒᵣ/N, where N is a number (N>1) of desired planes in the z-stack. In addition, a repetitive axial shift (e.g., focus shift) may be performed between frames such that each frame may capture a different focal plane. The resulting scan may image the entire FOV at N different focal planes for each FOV in the scanned area, except, in some examples, the FOVs near the circumference of the scanned area.

A stitching algorithm may be applied during or after the acquisition to create a 3D z-stack that may allow a user to digitally change the focal plane. Alternatively, the stitching algorithm may produce an all in-focus 2D image, or otherwise process the captured frames to enhance certain features. For example, the acquired z-stack may be used to enhance image quality by exploiting correlations between different planes for denoising. Moreover, additional information from the sample may be extracted, for instance, to reconstruct phase information from the z-stack.

Although the systems and methods described herein do not require a focus map for axial movement, in some examples, a correction to the repetitive axial movement may be applied by overlaying the repetitive axial movement on top of the focus map (see, e.g., FIG. 5). Moreover, in some examples, the repetitive axial movement may not necessarily be periodical. For example, the repetitive axial shift (when viewed without other axial shifts such as due to a predetermined focus map) may produce a pattern that changes directions repetitively at least once over the time needed to laterally scan approximately 2 FOVs (as in FIG. 4), but without necessarily repeating exactly periodically. Thus, the systems and methods herein may address the problem of poor scan quality due to inexact focus or sample thickness requiring acquisition of multiple focal planes.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor. The processor may comprise a distributed processor system, e.g. running parallel processors, or a remote processor such as a server, and combinations thereof

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

The present disclosure includes the following numbered clauses.

Clause 1. A scanning microscope comprising: a stage to hold a sample; an illumination source configured to illuminate the sample; an image capture device configured to capture a plurality of images of the sample within a field of view of the image capture device; a lateral actuator configured to change a relative lateral position between the image capture device and an imaged portion of the sample within the field of view of the image capture device for each of the plurality of images; a focus actuator configured to adjust a focal distance between the sample and the image capture device between each of the plurality of images; and a processor operatively coupled to the lateral actuator and the focus actuator to move the sample laterally relative to the field of view and capture an area of the sample at least three times for at least three lateral positions and at least three focal planes for each of a plurality of movement paths.

Clause 2. The scanning microscope of clause 1, wherein the lateral actuator and the focus actuator move simultaneously to define the plurality of movement paths, each of the plurality of movement paths comprising the at least three focal planes and the at least three lateral positions.

Clause 3. The scanning microscope of clause 1, wherein the processor is configured with instructions to continuously move the sample laterally relative to the field of view for each of the plurality of movement paths.

Clause 4. The scanning microscope of clause 3, wherein the processor is configured with instructions to continuously move the sample laterally with a velocity relative to the field of view for each of the plurality of movement paths.

Clause 5. The scanning microscope of clause 1, wherein the at least three focal planes are located at a plurality of axial positions along an optical axis of the image capture device.

Clause 6. The scanning microscope of clause 5, wherein the plurality of axial positions comprises at least three axial positions.

Clause 7. The scanning microscope of clause 5, wherein the plurality of axial positions comprises a first axial position and a second axial position and wherein a first focal plane is located at the first axial position and wherein a second focal plane and a third focal plane are located at the second axial position.

Clause 8. The scanning microscope of clause 1, wherein the plurality of movement paths comprises periodic movement of the focus actuator while the lateral actuator continues advancement of the sample in relation to the field of view.

Clause 9. The scanning microscope of clause 8, wherein the focus actuator is adjusted from a third position of a first movement path to a first position of a second movement path and wherein the focus actuator moves from first, second and third positions of the second movement path while the lateral actuator continues advancement of the sample in relation to the field of view to corresponding first, second and third lateral positions of the sample along the second movement path.

Clause 10. The scanning microscope of clause 1, wherein for said each of the plurality of movement paths the lateral actuator moves from a first lateral position of the sample, to a second lateral position of the sample, and to a third lateral position of the sample, the second lateral position between the first lateral position and the third lateral position and wherein the focus actuator moves from a first focal plane position corresponding to the first lateral position, to a second focal plane position corresponding to the second lateral position, and to a third focal plane position corresponding to the third lateral position, the second focal plane position between the first focal plane position and third focal plane position.

Clause 11. The scanning microscope of clause 1, wherein the processor is further configured to adjust at least one of the plurality of movement paths.

Clause 12. The scanning microscope of clause 11, wherein an adjustment to the at least one of the plurality of movement paths is based on a slide tilt compensation.

Clause 13. The scanning microscope of clause 11, wherein an adjustment to the at least one of the plurality of movement paths is based on a predetermined focus map.

Clause 14. The scanning microscope of clause 11, wherein an adjustment to the at least one of the plurality of movement paths is based on a focus of the sample of a prior measurement path.

Clause 15. The scanning microscope of clause 1, further comprising a processor configured to process the plurality of images.

Clause 16. The scanning microscope of clause 15, wherein the processor is configured to form a focal stack from the plurality of images.

Clause 17. The scanning microscope of clause 16, wherein the processor is configured to form the focal stack by: identifying images of the plurality of images corresponding to a same lateral field of view of the sample at different focal planes; laterally aligning the identified images; and combining the laterally aligned images into the focal stack.

Clause 18. The scanning microscope of clause 16, wherein the processor is further configured to interpolate, in a z-direction, between acquired layers of the focal stack.

Clause 19. The scanning microscope of clause 16, wherein the processor is further configured to digitally refocus the focal stack.

Clause 20. The scanning microscope of clause 15, wherein the processor is configured to process the plurality of images to generate a two-dimensional image from the plurality of images.

Clause 21. The scanning microscope of clause 20, wherein the sample comprises an object at different focal planes in a focal stack of images and the two-dimensional image comprises an in focus image of the object from different focal planes and wherein the processor is configured to generate the two-dimensional image by: generating the focal stack from the plurality of images; identifying a plurality of portions of the plurality of images corresponding to a same lateral field of view of the sample at the different focal planes; and combining the plurality of portions to generate the two-dimensional image.

Clause 22. The scanning microscope of clause 20, wherein the processor is configured to generate the two-dimensional image by: identifying images of the plurality of images corresponding to a same first lateral field of view of the sample at different focal planes; selecting, from the identified images corresponding to the first lateral field of view, a first in-focus image; identifying images of the plurality of images corresponding to a same second lateral field of view of the sample at different focal planes; selecting, from the identified images corresponding to the second lateral field of view, a second in-focus image; and combining the first in-focus image with the second in-focus image to create the two-dimensional image.

Clause 23. The scanning microscope of clause 15, wherein the processor is configured to perform, using the plurality of images, one or more of motion blurring correction, phase retrieval, optical aberration correction, resolution enhancement, or noise reduction.

Clause 24. The scanning microscope of clause 15, wherein the processor is configured to create a three-dimensional reconstruction of the sample using the plurality of images.

Clause 25. The scanning microscope of clause 15, wherein the processor is configured to determine, based on the plurality of images, a center of mass of the sample.

Clause 26. The scanning microscope of clause 25, wherein determining the center of mass comprises estimating a correct focus using two-dimensional data derived from the plurality of images.

Clause 27. The scanning microscope of clause 25, wherein determining the center of mass comprises estimating a center, in a z-direction, of three-dimensional data derived from the plurality of images.

Clause 28. The scanning microscope of clause 1, wherein the illumination source comprises a Kohler illumination source.

Clause 29. The scanning microscope of clause 1, wherein the illumination source is configured to emit polychromatic light.

Clause 30. The scanning microscope of clause 29, wherein the polychromatic light comprises white light.

Clause 31. The scanning microscope of clause 1, wherein the image capture device comprises a color camera.

Clause 32. The scanning microscope of clause 1, wherein the illumination source comprises a plurality of light sources and optionally wherein the plurality of light sources comprises a plurality of LEDs.

Clause 33. The scanning microscope of clause 32, wherein each of the plurality of light sources is configured to illuminate the sample at an angle different from illumination angles of other light sources of the plurality of light sources.

Clause 34. The scanning microscope of clause 33, wherein the plurality of light sources is arranged to sequentially illuminate the sample at different angles to provide one or more of digital refocusing, aberration correction or resolution enhancement.

Clause 35. The scanning microscope of clause 32, wherein each of the plurality of light sources is configured to emit a different wavelength of light from other light sources of the plurality of light sources.

Clause 36. The scanning microscope of clause 32, wherein the each of the plurality of light sources is configured to emit light with a full width half maximum bandwidth of no more than 50 nm so as to emit substantially monochromatic light.

Clause 37. The scanning microscope of clause 32, wherein the controller is configured to apply each of a plurality of light colors for a first iteration of the plurality of movement paths and to apply said each of the plurality of light colors for a second iteration of the plurality of movement paths.

Clause 38. The scanning microscope of clause 1, wherein the focus actuator comprises a coarse actuator for long range motion and a fine actuator for short range motion.

Clause 39. The scanning microscope of clause 38, wherein the coarse actuator remains fixed while the focus actuator adjusts the focal distance and the lateral actuator moves the lateral position of the sample for each of the plurality of movement paths.

Clause 40. The scanning microscope of clause 38, wherein the coarse actuator comprises one or more of a stepper motor or a servo motor.

Clause 41. The scanning microscope of clause 38, wherein the fine actuator comprises a piezo electric actuator.

Clause 42. The scanning microscope of clause 38, wherein the fine actuator is configured to move the sample by a maximum amount within a range from 5 microns to 500 microns and the coarse actuator is configured to move the sample by a maximum amount within a range from 1 mm to 100 mm.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A scanning microscope comprising:
a stage to hold a sample;
an illumination source configured to illuminate the sample;
an image capture device configured to capture a plurality of images of the sample within a field of view of the image capture device;
a lateral actuator configured to change a relative lateral position between the image capture device and an imaged portion of the sample within the field of view of the image capture device for each of the plurality of images;
a focus actuator configured to adjust a focal distance between the sample and the image capture device between each of the plurality of images; and
a processor operatively coupled to the lateral actuator and the focus actuator to move the sample laterally relative to the field of view and capture an area of the sample at least three times for at least three lateral positions and at least three focal planes for each of a plurality of movement paths.

2. The scanning microscope of claim 1, wherein the lateral actuator and the focus actuator move simultaneously to define the plurality of movement paths, each of the plurality of movement paths comprising the at least three focal planes and the at least three lateral positions.

3. The scanning microscope of claim 1, wherein the processor is configured with instructions to continuously move the sample laterally relative to the field of view for each of the plurality of movement paths.

4. The scanning microscope of claim 3, wherein the processor is configured with instructions to continuously move the sample laterally with a velocity relative to the field of view for each of the plurality of movement paths.

5. The scanning microscope of claim 1, wherein the at least three focal planes are located at a plurality of axial positions along an optical axis of the image capture device.

6. The scanning microscope of claim 1, wherein the plurality of movement paths comprises periodic movement of the focus actuator while the lateral actuator continues advancement of the sample in relation to the field of view.

7. The scanning microscope of claim 1, wherein for said each of the plurality of movement paths the lateral actuator moves from a first lateral position of the sample, to a second lateral position of the sample, and to a third lateral position of the sample, the second lateral position between the first lateral position and the third lateral position and wherein the focus actuator moves from a first focal plane position corresponding to the first lateral position, to a second focal plane position corresponding to the second lateral position, and to a third focal plane position corresponding to the third lateral position, the second focal plane position between the first focal plane position and third focal plane position.

8. The scanning microscope of claim 1, wherein the processor is further configured to adjust at least one of the plurality of movement paths.

9. The scanning microscope of claim 8, wherein an adjustment to the at least one of the plurality of movement paths is based on a slide tilt compensation; or
wherein an adjustment to the at least one of the plurality of movement paths is based on a predetermined focus map; or
wherein an adjustment to the at least one of the plurality of movement paths is based on a focus of the sample of a prior measurement path.

10. The scanning microscope of claim 1, further comprising a processor configured to process the plurality of images.

11. The scanning microscope of claim 10, wherein the processor is configured to form a focal stack from the plurality of images.

12. The scanning microscope of claim 11, wherein the processor is configured to form the focal stack by:
identifying images of the plurality of images corresponding to a same lateral field of view of the sample at different focal planes;
laterally aligning the identified images; and
combining the laterally aligned images into the focal stack.

13. The scanning microscope of claim 11, wherein the processor is further configured to interpolate, in a z-direction, between acquired layers of the focal stack.

14. The scanning microscope of claim 11, wherein the processor is further configured to digitally refocus the focal stack.

15. The scanning microscope of claim 10, wherein the processor is configured to process the plurality of images to generate a two-dimensional image from the plurality of images.

16. The scanning microscope of claim 10, wherein the processor is configured to perform, using the plurality of images, one or more of motion blurring correction, phase retrieval, optical aberration correction, resolution enhancement, or noise reduction; or
wherein the processor is configured to create a three-dimensional reconstruction of the sample using the plurality of images.

17. The scanning microscope of claim 10, wherein the processor is configured to determine, based on the plurality of images, a center of mass of the sample.

18. The scanning microscope of claim 1, wherein the illumination source comprises a Kohler illumination source.

19. The scanning microscope of claim 1, wherein the illumination source comprises a plurality of light sources and optionally wherein the plurality of light sources comprises a plurality of LEDs; or
wherein each of the plurality of light sources is configured to illuminate the sample at an angle different from illumination angles of other light sources of the plurality of light sources.

20. The scanning microscope of claim 1, wherein the focus actuator comprises a coarse actuator for long range motion and a fine actuator for short range motion.
